(19) United States
(12) Patent Application Publication
(10) Pub. No.: US 2014/0257524 A1
(43) Pub. Date: Sep. 11, 2014

(54) SYSTEM FOR CONTROLLING CONTAINER DATA CENTERS

(71) Applicant: Hon Hai Precision Industry Co., Ltd., New Taipei (TW)

(72) Inventors: SHIH-CHIEH CHEN, New Taipei (TW); CHIH-HUNG CHANG, New Taipei (TW)

(21) Appl. No.: 13/942,715

(22) Filed: Jul. 16, 2013

(30) Foreign Application Priority Data
Mar. 6, 2013 (TW) 102107748

(51) Int. Cl. G05B 11/01

(52) U.S. Cl. CPC G05B 11/01
USPC 700/3

(57) ABSTRACT

A system for controlling container data centers (CDCs) includes a number of CDC groups, a number of slave monitoring systems, and a master monitoring system. Each CDC group includes a number of CDCs. Each slave monitoring system is connected to the CDCs of one CDC group via a network. Each slave monitoring system receives and processes data transmitted from the CDCs connected to the slave monitoring system, and transmits the processed data to the master monitoring system via the network. The master monitoring system receives the processed data from the slave monitoring systems, responds to user input to receive settings for controlling operation of the plurality of CDCs, and transmits the settings to the plurality of slave monitoring systems. The slave monitoring system transmit the settings to the CDCs connected to the slave monitoring systems. Each CDC operates according to the settings input by the user.

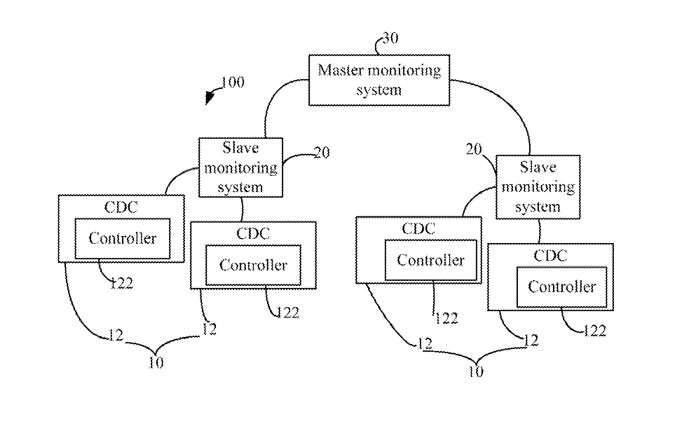

### BACKGROUND

1. Technical Field

The present disclosure relates to container data centers (CDCs), and particularly to a system to control container data centers.

2. Description of Related Art

Typically, a central monitoring system monitors a great number of container data centers arranged in different regions. Thus, the central monitoring system needs to process a great amount of data, therefore making it easy for the center monitoring system to break down. Thus, there is room for improvement in the art.

### BRIEF DESCRIPTION OF THE DRAWINGS

Many aspects of the present disclosure should be better understood with reference to the following drawing.

The drawing is a block diagram of a system for controlling CDCs, in accordance with an exemplary embodiment.

### DETAILED DESCRIPTION

Embodiments of the present disclosure are described in detail, with reference to the accompanying drawing.

Referring to the drawing, an embodiment of a system 100 includes a number of CDC groups 10 connected via a network (e.g. Internet), a number of slave monitoring systems 20, and a master monitoring system 30 connected to the slave monitoring systems 20 via the network. Different CDC groups are arranged in different regions. Each CDC group 10 includes a number of CDCs 12 connected to one slave monitoring system 20 via the network. Data generated by each CDC 12 is transmitted to the slave monitoring system 20 connected to the CDC 12. Each slave monitoring system 20 processes the received data and transmits the processed data to the master monitoring system 30. A user terminal (not shown), such as a computer for example, is connected to the master monitoring system 30 via the network, and can access the master monitoring system 30, thus allowing a CDC manager to monitoring system each CDC 12 via the user terminal.

In this embodiment, each CDC 12 includes a controller 122 to collect data generated by to-be-controlled modules of the CDC 12. The to-be-controlled modules of each CDC 12 include temperature and humidity sensors, fire-fighting equipment, air-conditioners, and power equipment. Each slave monitoring system 20 receives and stores the data transmitted from the controllers 122 of the CDCs 12, processes the received data, and transmits the processed data to the master monitoring system 30 via the network. The master monitoring system 30 receives and stores the processed data from the slave monitoring systems 20, receives settings for controlling the CDCs 12 from the CDC manager, and transmits the settings to the slave monitoring systems 20. Each slave monitoring system 20 transmits the settings to the controllers 122 of the CDCs 12 connected to the slave monitoring system 20. The controller 122 of each CDC 12 controls the operation of the CDC 12 according to the settings. In this embodiment, the CDC manager knows the operation of each CDC 12 by examining the data stored in the master monitoring system 30, and inputs the settings for controlling the operation of each CDC 12 via the master monitoring system 30.

In this embodiment, when the master monitoring system 30 determines that data needed by the CDC manager does not exist in the master monitoring system 30, the master monitoring system 30 commands the slave monitoring systems 20 to transmit the needed data to the master monitoring system 30.

In this embodiment, the master monitoring system 30 further communicates with a portable communication terminal (not shown) provided by the CDC manager. When the master monitoring system 30 determines that one or more CDCs 12 run abnormally according to the processed data, the master monitoring system 30 transmits a prompt to the portable communication terminal. Thus, the CDC manager can examine the abnormal CDCs 12 in time.

In this embodiment, the data received by the master monitoring system 30 is already processed by the slave monitoring systems 20. Thus, the processing burden of the master monitoring system 30 is greatly reduced, and breakdown of the master monitoring system 30 is avoided.

In this embodiment, the master monitoring system 30 provides a number of environmental classes for the CDC manager to select. Each environmental class corresponds to a season of the year, and includes environmental data on the season. The environmental data can be the temperature value and the humidity value for summer, for example. The master monitoring system 30 transmits the environmental data of the selected environmental class to the controllers 122 of the CDCs 12 via the slave masters 20. The controller 122 of each CDC 12 controls the operation of the CDC 12 to operate in an environment according to the environmental data transmitted by the master monitoring system 30. In this embodiment, there are four environmental classes. With such configuration, when the CDC manager selects one environmental class, without setting the environmental data one by one, the CDCs 12 automatically operate in the needed environment.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A system for controlling container data centers (CDCs), comprising:
a plurality of CDC groups each comprising a plurality of CDCs, each CDC comprising a controller to collect data generated by to-be-controlled modules of the CDC;
a plurality of slave monitoring systems each connected to the CDCs of one CDC group via a network, each slave monitoring system being to receive and process data transmitted from the controller of the CDCs connected to the salve monitoring system, and transmit the processed data to a master monitoring system via the network; and
the master monitoring system connected to the plurality of slave monitoring systems via the network, receive the processed data from the plurality of slave monitoring systems, respond to user input to receive settings for controlling operation of the plurality of CDCs, and transmit the settings to the plurality of slave monitoring systems;
wherein, each slave monitoring system is further to transmit the settings to the CDCs connected to the slave monitoring system, the controller of each CDC is further to control the operation of the CDC according to the settings.

2. The system as described in claim 1, wherein the master monitoring system further communicates with a portable communication terminal, when the master monitoring system determines that one or more CDCs run abnormally according to the processed data, the master monitoring system is to transmit a prompt to the portable communication terminal to inform the portable communication terminal of the one or more abnormal CDCs.

3. The system as described in claim 1, wherein when the master monitoring system determines data needed by a CDC manager does not exist in the master monitoring system, the master monitoring system commands the slave monitoring systems to transmit the needed data to the master monitoring system.

4. The system as described in claim 1, wherein the to-be-controlled modules of each CDC includes temperature and humidity sensors, fire-fighting equipments, air-conditions, and power equipments.

5. The system as described in claim 1, wherein the master monitoring system provides a plurality of environmental classes for a CDC manger to select, each environmental class corresponds to a season of the year and comprises environmental data on the season, the master monitoring system further transmits the environmental data of one selected environmental class to the controllers of the CDCs via the slave masters, the controller of each CDC controls the CDC to operate in an environment according to the environmental data of the selected environmental class.

6. The system as described in claim 5, wherein four environmental classes are provided.
